(19) United States
(12) Patent Application Publication
(10) Pub. No.: US 2026/0309739 A1
(43) Pub. Date: Oct. 8, 2026

(54) SYSTEM AND METHOD FOR RETAINING, STORING, AND CAPPING SAMPLES COLLECTED FROM A DISTANCE COINCIDENT WITH CHEMICAL ANALYSIS

(71) Applicant: Elemental Scientific, Inc., Omaha, NE (US)

(72) Inventors: Austin Schultz, Omaha, NE (US); David Diaz, Bennington, NE (US); Jonathan Hein, Omaha, NE (US)

(21) Appl. No.: 19/636,214

(22) Filed: Apr. 1, 2026

Related U.S. Application Data
(60) Provisional application No. 63/789,079, filed on Apr. 15, 2025.
(60) Provisional application No. 63/783,688, filed on Apr. 4, 2025.

(51) Int. Cl. G01N 35/10; G01N 35/00

(52) U.S. Cl. CPC G01N 35/1016; G01N 35/00584; G01N 2035/1025

(57) ABSTRACT

Systems and methods for automated retaining and storing chemical samples within capped sample vessels following chemical analysis of the samples collected from a remote location are described. In an aspect, an automated sample retention system includes, but is not limited to, an uncapper configured to remove and replace a cap from a bottle; a sample probe configured to dispense sample into an uncapped bottle; and a sample loop fluidically coupled with the sample probe and configured to hold sample, wherein the system introduces sample held in the sample loop to the uncapped bottle via the sample probe upon confirmation of availability of the bottle and detection of an analyte of interest within the sample that is less than a threshold amount.

### CROSS-REFERENCE TO RELATED APPLICATIONS

The present application claims the benefit of 35 U.S.C. §119(e) of U.S. Provisional Application Serial No. 63/783,688, filed Apr. 4, 2025, and titled “SYSTEM AND METHOD FOR RETAINING, STORING, AND CAPPING SAMPLES COLLECTED FROM A DISTANCE COINCIDENT WITH CHEMICAL ANALYSIS” and of U.S. Provisional Application Serial No. 63/789,079, filed Apr. 15, 2025, and titled “SYSTEM AND METHOD FOR RETAINING, STORING, AND CAPPING SAMPLES COLLECTED FROM A DISTANCE COINCIDENT WITH CHEMICAL ANALYSIS.” U.S. Provisional Application Serial Nos. 63/783,688 and 63/789,079 are herein incorporated by reference in this entireties.

### BACKGROUND

In many laboratory settings, it is often necessary to analyze a large number of chemical or biochemical samples at one time. In order to stream-line such processes, the manipulation of samples has been mechanized. Such mechanized sampling is commonly referred to as autosampling and is performed using an automated sampling device or autosampler.

Inductively Coupled Plasma (ICP) spectrometry is an analysis technique commonly used for the determination of trace element concentrations and isotope ratios in liquid samples. ICP spectrometry employs electromagnetically generated partially ionized argon plasma which reaches a temperature of approximately 7000K. When a sample is introduced to the plasma, the high temperature causes sample atoms to become ionized or emit light. Since each chemical element produces a characteristic mass or emission spectrum, measuring the spectra of the emitted mass or light allows the determination of the elemental composition of the original sample.

Sample introduction systems may be employed to introduce the liquid samples into the ICP spectrometry instrumentation (e.g., an Inductively Coupled Plasma Mass Spectrometer (ICP/ICP-MS), an Inductively Coupled Plasma Atomic Emission Spectrometer (ICP-AES), or the like) for analysis. For example, a sample introduction system may transport an aliquot of sample to a nebulizer that converts the aliquot into a polydisperse aerosol suitable for ionization in plasma by the ICP spectrometry instrumentation. The aerosol generated by the nebulizer is then sorted in a spray chamber to remove the larger aerosol particles. Upon leaving the spray chamber, the aerosol is introduced into the plasma by a plasma torch assembly of the ICP-MS or ICP-AES instruments for analysis.

### SUMMARY

Systems and methods for automated retaining and storing chemical samples within capped sample vessels following chemical analysis of the samples collected from a remote location are described. In an aspect, a system embodiment includes, but is not limited to, an analysis system configured to receive a fluid sample and measure an amount of one or more analytes of interest in the fluid sample; and a sample retention system fluidically coupled with the analysis system via a fluid transfer line, the sample retention system including an uncapper configured to remove a cap from a bottle to provide an uncapped bottle and to replace the cap to the bottle to provide a capped bottle, a sample probe configured to dispense the fluid sample into the uncapped bottle, a sample loop fluidically coupled with the sample probe and the fluid transfer line and configured to hold a portion of the fluid sample, and a controller communicatively coupled with the analysis system, the uncapper, and the sample probe, the controller configured to determine whether the amount of one or more analytes of interest in the fluid sample measured by the analysis system is within a threshold amount, transfer the portion of fluid sample into the sample loop to provide a retained sample portion, instruct the uncapper to remove the cap from the bottle to provide the uncapped bottle, instruct the sample probe to introduce the sample probe into the uncapped bottle, and transfer the retained sample portion from the sample loop, through the sample probe, and into the uncapped bottle to provide a retained sample.

In an aspect, a system embodiment includes, but is not limited to, a sample retention system fluidically coupled, via a fluid transfer line, with an analysis system an analysis system configured to receive a fluid sample and measure an amount of one or more analytes of interest in the fluid sample, the sample retention system including an uncapper configured to remove a cap from a bottle to provide an uncapped bottle and to replace the cap to the bottle to provide a capped bottle, a sample probe configured to dispense the fluid sample into the uncapped bottle, a sample loop fluidically coupled with the sample probe and the fluid transfer line and configured to hold a portion of the fluid sample, and a controller communicatively coupled with the uncapper and the sample probe, the controller configured to transfer the portion of fluid sample into the sample loop to provide a retained sample portion when the amount of one or more analytes of interest in the fluid sample measured by the analysis system is within a threshold amount, instruct the uncapper to remove the cap from the bottle to provide the uncapped bottle, instruct the sample probe to introduce the sample probe into the uncapped bottle, and transfer the retained sample portion from the sample loop, through the sample probe, and into the uncapped bottle to provide a retained sample.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### DRAWINGS

The Detailed Description is described with reference to the accompanying figures. The use of the same reference numbers in different instances in the description and the figures may indicate similar or identical items.

FIG. 1 is a diagrammatic view of an automated system for retaining and storing chemical samples within capped sample vessels following chemical analysis of the samples collected from a remote location in accordance with an example embodiment of the present disclosure.

FIG. 2 is a method flow diagram for retaining and storing chemical samples within capped sample vessels in accordance with an example embodiment of the present disclosure.

FIG. 3A is a diagrammatic view of a sample retention system of the system of FIG. 1 in accordance with an example embodiment of the present disclosure.

FIG. 3B is a top view of the sample retention system of FIG. 3A.

FIG. 4A is a partial perspective view of an uncapper of the sample retention system of FIG. 3A, shown interacting with a cap of a sample vessel in accordance with an example embodiment of the present disclosure.

FIG. 4B is a partial perspective view of the uncapper of FIG. 4A, shown lifting the cap from the sample vessel in accordance with an example embodiment of the present disclosure.

FIG. 5 is a flow diagram of a method for retaining and storing chemical samples within capped sample vessels following chemical analysis of the samples collected from a remote location and subsequently verifying the retained samples within the sample vessels in accordance with an example embodiment of the present disclosure.

### DETAILED DESCRIPTION

### Overview

Often in laboratory or industry settings, large numbers of samples are analyzed. Autosamplers are frequently used to gather and introduce samples for subsequent testing of the composition of these samples. Using an autosampler typically allows more samples and other solutions to be prepared and tested as compared to manual preparation methods. During the sample preparation process, multiple containers may be used to prepare samples, prepare standards (e.g., to generate one or more calibration curves), introduce standard spikes to a sample, hold various reagents, hold samples, or the like. The source of the sample can vary depending on the system. For example, in industrial settings, the source of the sample can be a chemical storage tank, chemical receiving dock, chemical loading dock, or other location that can be remote (e.g., hundreds or thousands of meters) from chemical laboratory stations used to test the purity of the sample.

Determination of trace elemental concentrations or amounts in a sample can provide an indication of purity of the sample, or an acceptability of the sample for use as a reagent, reactive component, or the like. For instance, in certain production or manufacturing processes (e.g., mining, metallurgy, semiconductor fabrication, chemical production, pharmaceutical processing, etc.), the tolerances for impurities can be very strict, for example, on the order of fractions of parts per billion. For example, semiconductor processes can require ultralow detection limits for impurities in process chemicals including, but not limited to, ultrapure water (UPW) for washing wafers, isopropyl alcohol (IPA) for drying wafers, hydrogen peroxide (H2O2), ammonia solution (NH4OH), and the like. Failure to detect ultralow concentrations of impurities in such process chemicals can ruin a semiconductor wafer, such as by precipitating such impurities out of solution and onto the wafer (e.g., depositing a metallic impurity or other conductivity hazard onto the wafer, such as through precipitation of the impurity out of solution, the wafer acting as a concentrator surface for the impurity, or the like).

In many situations, chemical samples are retained to provide an opportunity for a future reanalysis of the sample. However, many chemical analysis systems discard the tested sample or otherwise make a sample unsuitable for reanalysis after an initial analysis has occurred. Attempting to manually recollect a sample provides many opportunities to introduce error to the sample, such as by misidentifying a sample or a source of the sample. Moreover, many chemical samples are hazardous to individuals, where manual recollection of sample provides risk of exposure of the hazardous chemical to laboratory staff, factory technicians, and other personnel. However, leaving samples in the laboratory that could otherwise be saved for reanalysis involves other risks, such as venting portions of the sample (e.g., undesirably concentrating the sample), requiring staff to manually track the status and location of the sample, requiring staff to repetitively introduce caps, lids, septums, or the like to the sample vessels (e.g., risking repetitive stress injury, exposure to the chemical, etc.), or the like. Moreover, attempting to manually save every sample, including samples that are unfit for use or sale, introduces an administrative and storage space burden to appropriately track and store every sample.

Accordingly, systems and methods are disclosed for automated retaining and storing chemical samples within capped sample vessels following chemical analysis of the samples collected from a remote location. In an aspect, a system includes an analysis system to receive a fluid sample from a remote location via a sample transfer line and to determine an amount or concentration of one or more analytes of interest within the fluid sample. The system also includes a sample retention system to identify and verify a sample bottle as being available to receive and retain a sample following analysis by the analysis system or on demand (e.g., via a user command). The sample retention system is fluidically coupled with a remote sample source and can include a valve system and fluid lines to receive sample from the remote sample source, introduce the sample into the verified sample bottle, and introduce a cap or seal to the sample bottle with the sample held therein.

In aspects, the sample retention system includes an uncapper and a sample probe, where the uncapper moves into position over sample vessel, removes and retains a cap from the sample vessel while allowing access to the internal volume of the sample vessel to the sample probe. The sample probe can be positioned into or above the internal volume of the sample vessel to dispense sample into the sample vessel for subsequent recapping by the uncapper. For example, the sample retention system can include a sample loop fluidically coupled with a sample transfer line and with the sample probe to receive sample into the sample retention system and dispense sample from the sample probe into a sample vessel that has been verified as available and empty. In aspects, the bottle is pre-rinsed with a portion of sample that has been determined by the analysis system to have one or more analytes of interest within the fluid sample below a threshold value prior to introducing an aliquot of the sample into the bottle for retention.

### Example Implementations

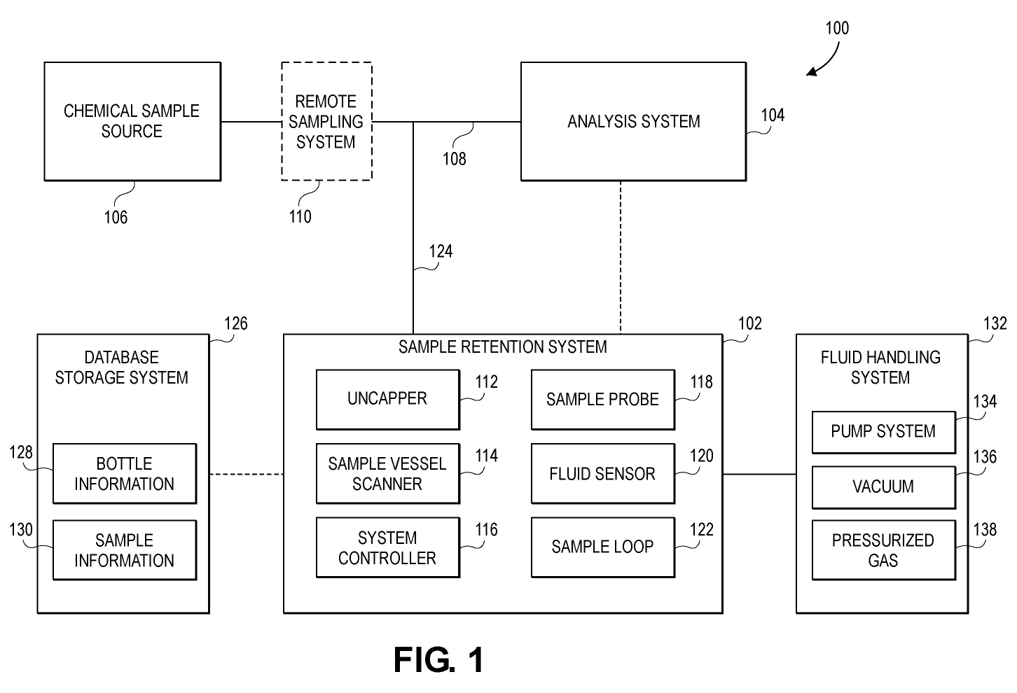

Referring to FIGS. 1-5, an automated system for retaining and storing chemical samples within capped sample vessels following chemical analysis of the samples collected from a remote location (“system 100”) is shown in accordance with example embodiments of the present disclosure. The system 100 generally includes a sample retention system 102 and an analysis system 104 fluidically coupled with a chemical sample source 106 via a transfer line 108 to receive a fluid sample from the chemical sample source 106 for analysis. For example, the analysis system 104 can include, but is not limited to, an inductively-coupled plasma analysis instrument (e.g., e.g., an Inductively Coupled Plasma Mass Spectrometer (ICP/ICP-MS), an Inductively Coupled Plasma Atomic Emission Spectrometer (ICP-AES), or the like), organic mass spectrometry, gas chromatography (GC), liquid chromatography (LC), liquid chromatography mass spectrometry (LC-MS), ion chromatography (IC), or another analytical instrument or technique to identify the presence and amount or concentration of one or more analytes of interest within the fluid sample. In implementations, the fluid sample can be obtained by a remote sampling system 110 fluidically coupled with the chemical sample source 106 for transfer to the analysis system 104 via the transfer line 108 through action of a pump system, pressurized gas transfer, or the like, or combinations thereof. For example, the remote sample system 110 can include, but is not limited to, the remote sampling system described in U.S. Patent No. 10,585,108, incorporated by reference herein.

The sample retention system 102 provides automated retention of fluid samples from the chemical sample source 106, such as when the analysis system 104 determines that the fluid sample is within specified standards for sale or use. For instance, the retained samples can be aliquots of a chemical held by a specific container vehicle that ships the chemical from a production plant or to the remote location, a lot or storage tank of chemical that is held by a manufacturer or user, or the like, for retention to test against if future issues arise with the chemical. Such issues can include, but are not limited to, if a fluid sample initially passes a chemical analysis, but later develops precipitates or particles, later particles dissolve into solution, or the like, that cause one or more analytes of interest in the sample to differ than when initially tested (e.g., prior to retention). The sample retention system can collect and retain a fluid sample from the chemical sample source 106 into a sample vessel with a cap secured thereto, such as following analysis by the analysis system 104, following confirmation by the analysis system 104 that the fluid sample maintains analytes of interest below a threshold standard, on demand by a user of the system 100 (e.g., via a user input), or the like, or combinations thereof.

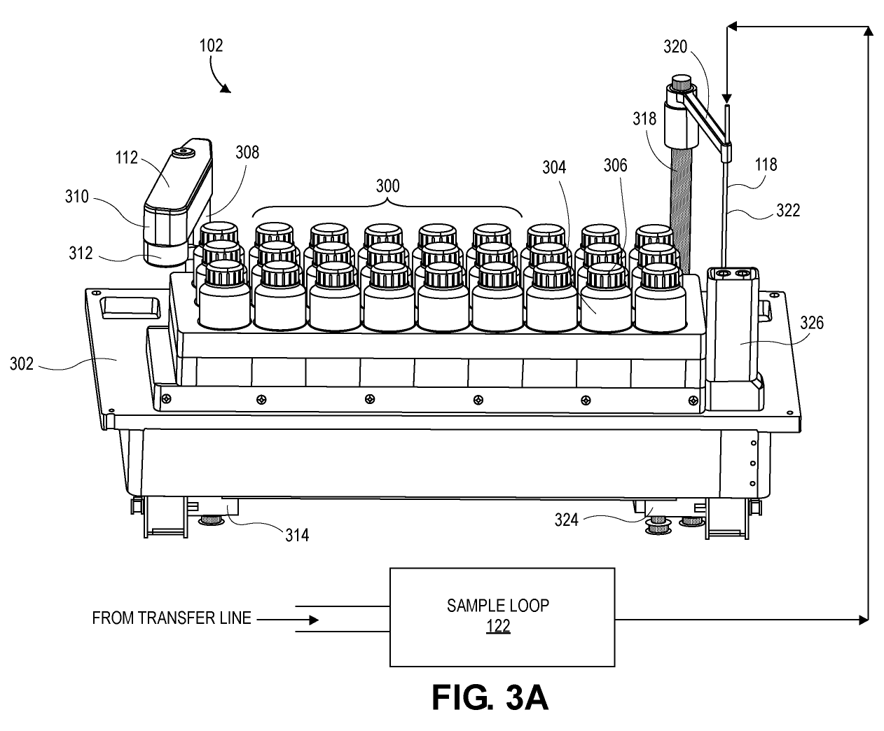

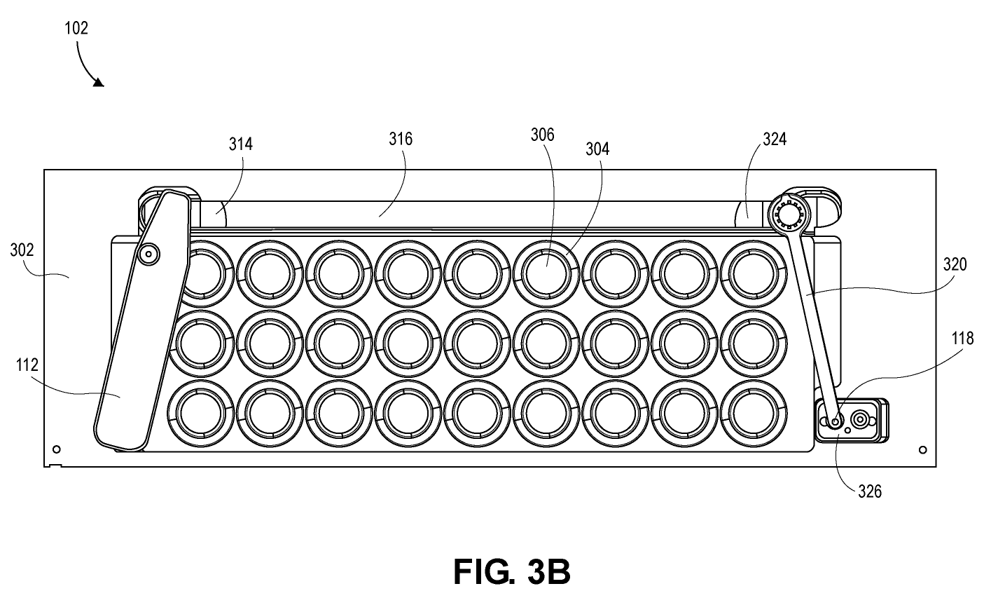

The sample retention system 102 is shown generally including an uncapper 112, a sample vessel scanner 114, a system controller 116, a sample probe 118, a fluid sensor 120, and a sample loop 122 to facilitate operations described herein to collect and retain a fluid sample from the chemical sample source 106 into a sample vessel with a cap secured thereto. For instance, referring to FIGS. 3A and 3B, an example of the sample retention system 102 is shown supporting a plurality of capped sample vessels 300 on a sample deck 302 to receive and retain a plurality of fluid samples from one or more of the chemical sample sources 106 via the sample probe 118. The sample vessels 300 are shown including a bottle base 304 with a screw cap 306, however the system 100 is not limited to this configuration and can accommodate any suitable covered sample container to retain samples including, but not limited to, sample vials, sample cylinders, centrifugal tubes, threaded caps, unthreaded caps, lids, coverings, or the like, without departing from the scope of the present disclosure. The uncapper 112 generally includes a z-axis support 308, an uncapper body 310, and a cap interface 312. The z-axis support 308 provides rotational, translational, and vertical movement of the uncapper body 310 with respect to sample deck 302 of the retention system 102. In implementations, the z-axis support 308 is driven via a first motor 314 which provides vertical and rotational motion of the z-axis support 308 and also provides translational motion of the z-axis support 308 through a channel 316 formed through the sample deck 302 of the retention system 102. The uncapper body 310 is coupled to each of the z-axis support 308 and the cap interface 312, such that motion of the z-axis support 308 is translated to each of the uncapper body 310 and the cap interface 312 to position the cap interface 312 relative to caps 306 of sample vessels 300 supported by the sample deck 302.

The sample probe 118 is shown generally including a z-axis support 318, a probe support arm 320, and a tubular probe 322. In implementations, the z-axis support 318 is driven via a second motor 324 which provides vertical and rotational motion of the z-axis support 318 and also provides translational motion of the z-axis support 318 through the channel 316 formed through the sample deck 302 of the retention system 102. The probe support arm 320 is coupled to each of the z-axis support 318 and the probe 322, such that motion of the z-axis support 318 is translated to each of the probe support arm 320 and the probe 322 to position the probe 322 relative to bottle base 304 (e.g., to introduce fluids to an interior of the bottle base 304 for retention following removal of the cap 306 by the uncapper 112), to position the probe 322 at a rinse station 326 or other portion of the retention system 102, and the like.

The system 100 facilitates tracking of sample identity to coordinate receipt of a given sample originating from the chemical sample source 106 into a given sample bottle for retention of the sample and for accurate recording of the presence of the given sample in the given sample bottle. For example, referring to FIG. 1, the system 100 is shown including a database storage system 126 communicatively coupled with the sample retention system 102 to store information associated with sample bottles (e.g., bottle information 128) and with chemical samples (e.g., sample information 130). In implementations, a user, such as a laboratory technician, can scan, via the sample vessel scanner 114, an identifier on each sample bottle at the sample retention system 102 whereby the system 100 can verify that the bottle is in a state to receive sample. The identifier can include, but is not limited to, a barcode, an RFID tag, a QR code, or the like, with information accessible by or stored in the database storage system 126. For example, the identifier can be associated with a data entry in the database storage system 126 to track information associated with the bottles, such as to associate a clean state, a contaminated state, a filled state, and empty state, or the like, for each identifier for each bottle.

The system 100 can check that each bottle scanned at the sample retention system 102 is in a clean and empty state whereby the user can then place the bottle at the sample retention system 102. If a bottle is scanned that has a contaminated or filled state, the system 100 can generate an error, allowing the user to avoid using that bottle and/or to replace with a different bottle. Alternatively or additionally, the system 100 can automatically scan bottles at the sample retention system 102 without manual input by a user, such as, for example, with the sample retention system 102 including the container placement system and rotary uncapper as described in U.S. Patent Application No. 19/051,887, incorporated by reference herein, to transfer bottles from a sample rack or location on a sample deck to the rotary uncapper for scanning by the sample vessel scanner 114. In implementations, the sample retention system 102 can verify that a bottle to receive the chemical sample does not already contain fluid, independent of the status of the bottle database, through operation of the sample probe 118 and fluid sensor 120, as described herein.

The system 100 can also assign an identity of the chemical sample from the chemical sample source 106 and associate the identity of the specific bottle or bottles with which an aliquot of the chemical sample is being placed. For instance, the sample vessel scanner 114 can be communicatively coupled with the database storage system 126 to assign and store a sample identity associated with the bottle identifier present on the bottle (e.g., coordinated with the system controller 116) such that the system 100 can sort and retrieve data associated with, but not limited to, chemical identity and sample bottle, chemical type present in any sample bottles or in a specific sample bottle, chemical identities originated from a specific chemical sample source 106 present in any sample bottles or in a specific sample bottle, or the like.

The sample retention system 102 can establish an identity of a given chemical sample to assign to a particular bottle according to a variety of mechanisms. For example, the sample retention system can establish the identity of a given chemical sample automatically based on information associated with introduction of the chemical sample by the remote sampling system 110 (e.g., based on a time of receipt into the remote sampling system 110 from the chemical sample source 106, based on an identity of the chemical sample source 106, etc., and combinations thereof), based on an identity for the chemical sample provided by the analysis system 104 (e.g., based on a time of sample analysis, based on an amount of chemical analyte present (e.g., an amount of chemical analyte that exceeds a threshold, an amount of chemical analyte under a threshold, etc.) based on a sample ID assigned by the analysis system 104, or combinations thereof), based on manual entry by a user via a user input at the sample retention system 102 or communicatively coupled with the sample retention system 102, or the like, or combinations thereof.

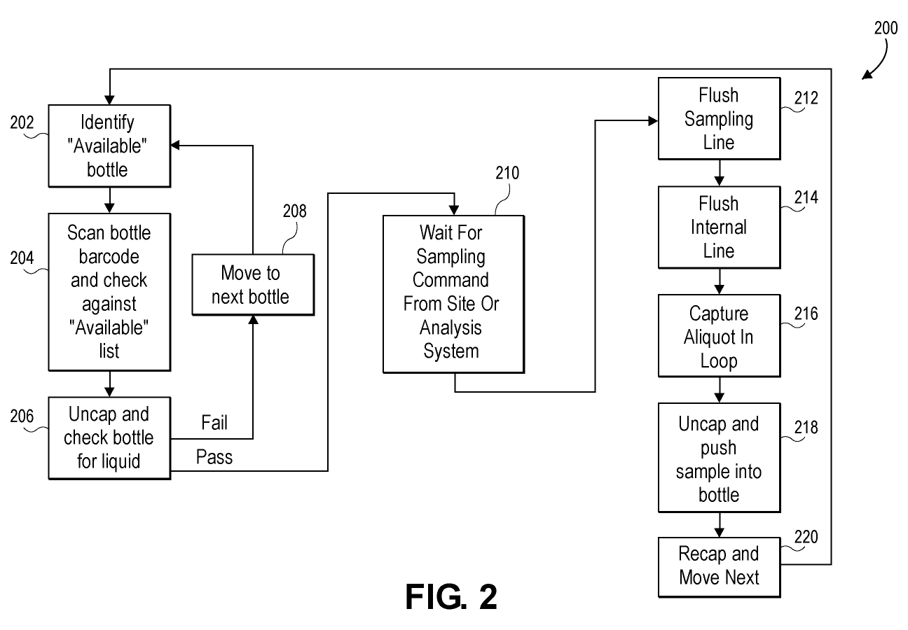

Referring to FIG. 2, a method for retaining and storing chemical samples within capped sample vessels (“method 200”) is shown in accordance with example embodiments of the present disclosure. The method 200 includes identifying an available bottle for receiving a fluid sample in block 202. For example, the system 100 can execute two verification checks to identify an available bottle, where the first verification check includes scanning the bottle barcode and checking the identifier against a list of available bottles in block 204 and the second verification check includes uncapping and checking the bottle for liquid within the bottle in block 206. In implementations, scanning the bottle barcode and checking the identifier against a list of available bottles includes automatically introducing the sample vessel scanner 114 to a given bottle at the sample retention system 102 (e.g., by passing a scan arm supporting the sample vessel scanner 114 past the sample identifier on the bottle, by picking and placing the bottle into proximity of the sample vessel scanner 114, or the like), whereby a bottle status is accessed from the database storage system 126 by the system controller 116 for verification of whether the bottle associated with the scanned identifier includes an available status.

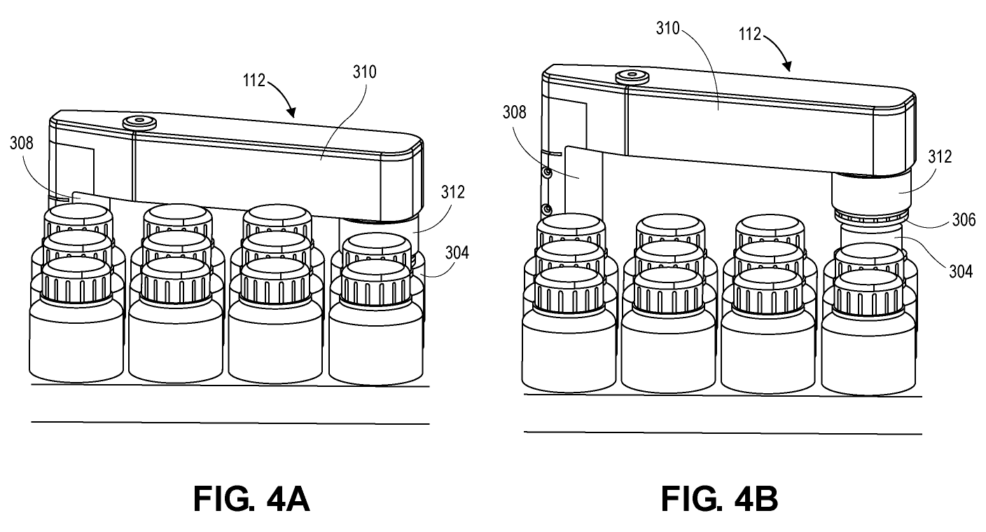

In implementations, the second verification check includes checking for liquid within the bottle by removing the cap on the bottle with the uncapper 112 with subsequent introduction of the sample probe 118 into an interior of the uncapped bottle (e.g., adjacent the bottom surface). The sample retention system 102 then attempts to draw any fluid from within the interior of the bottle through the sample probe 118 (e.g., by fluidically coupling the 322 with a pump or vacuum source) for verification of the presence or absence of fluid in the bottle. The uncapper 112 and the sample probe 118 can be configured as the uncapper and sample probe described in U.S. Patent Application No. 17/834,331, incorporated by reference herein. For example, referring to FIG. 3A, the retention system 102 is shown including the uncapper 112 and the sample probe 118 suspended above the sample deck 302. The retention system 102 is shown in FIG. 4A positioning the z-axis support 308 to bring the cap interface 312 above the desired sample bottle 300 and lowering the cap interface 312 (e.g., via lowering the uncapper body 310 along the z-axis support 308) into proximity with the cap 306 of the desired sample bottle 300. For example, the system controller 116 can verify the availability of a given bottle 300 for sample retention, associate and store the bottle identifier with a sample identity in the database storage system 126, and position the cap interface 312 above the bottle 300 (e.g., via indexing or other positioning system). The uncapper 112 can then remove the cap 306 from the bottle base 304, shown in FIG. 4B, such as through vacuum suction, unthreading, or the like, or combinations thereof, to provide access by the sample probe 118 to an interior of the bottle base 304.

In implementations, the cap interface 312 defines an interior region into which at least a portion of the cap 306 fits to provide physical interaction between an interior surface of the interior region and an exterior surface of the cap 306. For example, the cap interface 312 can include one or more protrusions, ridges, surface features or the like extending from or forming a portion of the interior surface that correspond to or physically interact with an outer surface of the cap 306.

Alternatively or additionally, the sample retention system 102 can include the uncapper 112 configured as the rotary uncapper as described in U.S. Patent Application No. 19/051,887, incorporated by reference herein, where the container placement system lifts sample bottles to and from a sample deck for introduction to the rotary uncapper to make available the interior of the bottle to the sample probe 118.

Referring to FIG. 1, the system 100 is shown including a fluid handling system 132 to facilitate introduction of fluids to the sample retention system from other portions of the system 100 (e.g., from the chemical sample source 106, from the remote sampling system 110, from the analysis system 104, or combinations thereof) and from the sample retention system 102 to other portions of the system 100 (e.g., to the analysis system 104). For example, the fluid handling system 132 can include, but is not limited to, a pump system 134, a vacuum source 136, and a pressurized gas 138. The pump system 134 can include one or more pumps including syringe pumps, peristaltic pumps, or the like. With the cap 306 removed from the bottle base 304 and with the sample probe 322 introduced into the interior of the bottle base 304, the system controller 116 can activate the fluid handling system 132 to draw liquid or air from the bottle base 304. For example, the fluid handling system 132 can draw liquid or air from the bottle base 304 through the sample probe 322 and into the sample loop 122 or another fluid line. The fluid sensor 120 can be positioned proximate the sample loop 122 (e.g., at an entrance to the sample loop 122, at an exit from the sample loop 122, or combinations thereof) or another fluid line to detects if any liquid is transferred past the fluid sensor 120. For example, the fluid sensor 120 can include, but is not limited to, one or more optical sensors, pressure sensors, ultrasonic transducers, conductivity sensors, or other sensors, and combinations thereof. The fluid sensor 120 can generate a sense signal accessible by the system controller 116 for determination of whether a liquid is detected (e.g., indicative of the presence of liquid in the bottle base 304) or whether a gas or no liquid is detected (e.g., indicative of the absence of liquid in the bottle base 304). If liquid is detected, the bottle fails the check for availability at block 206 of the method 200, whereby the system 100 proceeds to moving the uncapper 112 and/or the fluid prove 118 to the next bottle to verify its availability in block 208. If no liquid is detected, the bottle passes the check for availability and is ready to receive a fluid sample from the chemical sample source 106 for retention.

With an available bottle identified, the method 200 can then proceed to block 210, where the sample retention system 102 awaits a trigger for initiating introduction of a sample to the available bottle. In implementations, the trigger to introduce the fluid sample (e.g., from the chemical sample source 106, from the remote sampling system 110, from the analysis system 104, or combinations thereof) into the available bottle can include a command from the system 100 indicative of an outcome of analysis by the analysis system 104 or an on-demand command from a user (e.g., present at the sample retention system 102). For instance, the outcome of analysis by the analysis system 104 can include, but is not limited to, an outcome that the sample includes chemical analytes of interest at or below a threshold standard, an outcome that the sample includes chemical analytes of interest at or above a threshold standard, or the like. For example, the trigger to introduce sample into the available bottle can be that the analysis system 104 detected chemical analytes of interest at or below a threshold standard, indicative that the sample is suitable for use in chemical processing, where the sample is desired to be retained in the event that a future retest of the sample is desired.

The method 200 proceeds from block 210 to block 212, where a sampling line is flushed in preparation to transfer the sample into the available bottle. For example, the sample retention system 102 can be fluidically coupled with the chemical sample source 106 via a sampling line 124 that couples with one or more of the transfer line 108 or directly with the chemical sample source 106. In implementations, the sampling line 124 is flushed, through action of the fluid handling system 132, with a volume of sample that exceeds the volume of the sampling line 124. For example, at least three times the volume of the sampling line 124 can be flushed with sample, however the system 100 is not limited to such volume, where volumes of less than three times the volume of the sampling line 124 or volumes of more than three times the volume of the sampling line 124 can be introduced without departing from the scope of the present disclosure. The method 100 also includes flushing internal fluid lines of the sample retention system 102 in block 214. For example, the internal fluid lines can include, but are not limited to, the sample loop 122, fluid lines coupled between the sample loop 122 and the sample probe 118, valve systems of the sample retention system 102, and combinations thereof. In implementations, the internal fluid lines of the sample retention system 102 are flushed with a volume of sample that exceeds the volume of the internal fluid lines. For example, at least three times the volume of the internal fluid lines can be flushed with sample, however the system 100 is not limited to such volume, where volumes of less than three times the volume of the internal fluid lines or volumes of more than three times the volume of the internal fluid lines can be introduced without departing from the scope of the present disclosure.

The method 100 also includes capturing an aliquot of sample within a sample loop in block 216. For example, the sample loop 122 of the retention system can be loaded with sample received into the sample retention system 102 via the sampling line 124 in fluid communication with the sample loop 122 through action of the fluid handling system 132. The sample loop 122 can include a coil of fluid tubing, a line of fluid tubing, or the like suitable to hold a volume of sample to be introduction to the bottle for retention. In implementations, the sample loop 122 has a volume that is less than a volume of the bottle such that the entire volume of sample held in the sample loop 122 can be dispensed into an uncapped bottle held by the sample retention system 102 without overflow of sample from the bottle.

The method 200 also includes uncapping the bottle if the bottle is capped and pushing sample into the bottle in block 218. For example, if the bottle remains capped (e.g., the cap was returned following identification as an available bottle), the uncapper 112 can remove the cap from the bottle and reposition the cap to allow access to the interior of the bottle by the sample probe 118, whereby the sample probe 118 can be moved above or within the uncapped bottle to permit sample to be pushed or pulled from the sample loop 122 through the sample probe 118 and into the uncapped bottle via action by the fluid handling system 132. In implementations, prior to pushing the sample into the bottle from the sample loop 122, the bottle can be pre-rinsed with a portion of sample that has been determined by the analysis system 104 to have one or more analytes of interest within the fluid sample below a threshold value. In implementations, the system 100 can verify the status of the sample loop 122 using the fluid sensor 120 to notify when air or liquid is detected in the fluid line between the sample loop 122 and the sample probe 118. When the sample loop 122 is empty of sample, the sample retention system 102 removes the sample probe 118 from proximity of the bottle. The method then proceeds to block 220, where the cap is returned to the bottle and system 100 then removes the bottle from the list of available bottles in the database storage system 126, since the bottle now holds sample. The method 200 then returns to block 202 to identify the next bottle, or if all available bottles have been identified, to return to block 210 to await a trigger to introduce sample into the next available bottle to restart the retention method for another bottle. In implementations, the samples retention system 102 introduces the sample probe 118 to the rinse station 326 between introduction of samples into different bottles.

In implementations, the system 100 can perform a verification analysis of sample retained within the bottle to ensure that the bottle did not compromise the fluid sample that had already been analyzed by the analysis system 104 and determined not to include one more analytes above a threshold amount. For instance, the system 100 can determine whether the bottle included contaminate residue, prior sample residue, or the like, whether a capping procedure introduced a foreign contaminate to the retained sample, whether the bottle influenced particulate precipitation or dissolution, or combinations thereof. The verification can involve drawing a portion of retained sample from the bottle and analyzing the portion of retained sample to determine whether the retained sample includes one or more analytes that exceed a threshold value, that substantially differ from the level of analyte(s) analyzed in the initial sample taken from the chemical sample source 106, or combinations thereof. The verification can utilize the same analysis system 104 as used to analyze the initial sample from the chemical sample source 106, a different analysis system 104, or multiple analysis systems 104 to analyze how the results converge or diverge from the different analysis systems 104.

The verification can be performed according to one or more time periods following capture of the retained sample. For example, the verification can be performed according to one or more of: prior to capping the bottle with the retained sample held therein, immediately following capping of the bottle with the retained sample held therein, after passage of a time period following introduction of the retained sample to the bottle and prior to capping the bottle, after passage of a time period following capping the bottle with the retained sample held therein, or the like, or combinations thereof.

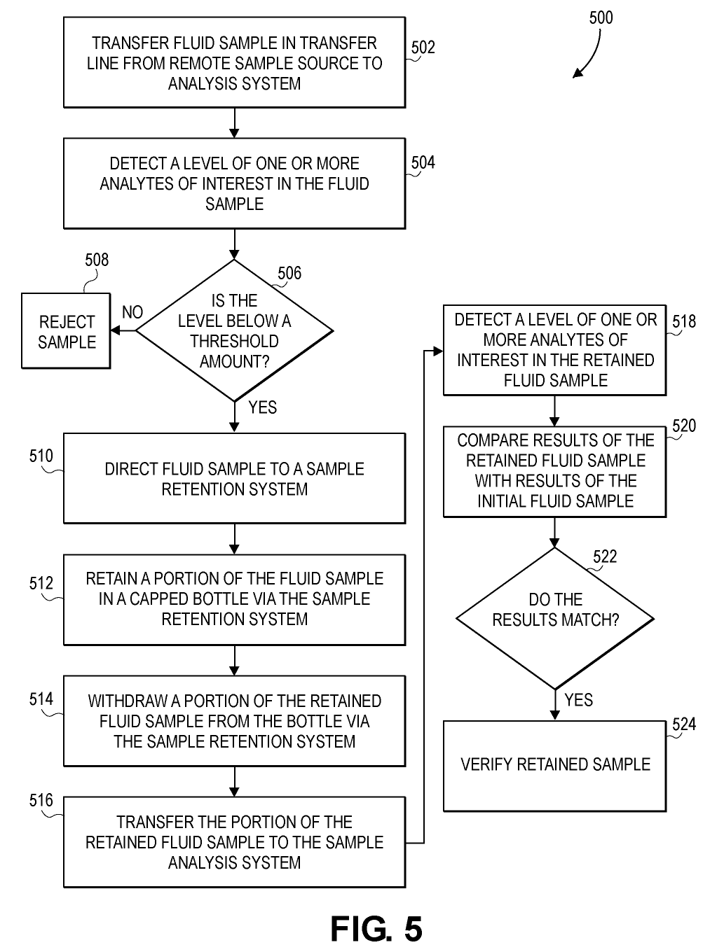

Referring to FIG. 5, a flow diagram of a method for retaining and storing chemical samples within capped sample vessels following chemical analysis of the samples collected from a remote location and subsequently verifying the retained samples within the sample vessels (“method 500”) is shown in accordance with an example embodiment of the present disclosure. The method 500 includes transferring a fluid sample in a transfer line from a remote sample source to an analysis system in block 502. For example, the fluid sample can be sourced from the chemical sample source 106 and transferred to the analysis system 104 via the transfer line 108, such as through action of the fluid handling system 132, through the remote sampling system 110, or combinations thereof.

The method 500 also includes detecting a level of one or more analytes of interest in the fluid sample in block 504. For example, the analysis system 104 can detect an amount or concentration of one or more analytes of interest (e.g., metals content, organic content, or the like) of the fluid sample received from a remote location, such as the chemical sample source 106 via the transfer line 108. The method 500 also includes determining whether the level of one or more analytes of interest is below a threshold amount in block 506. For example, the analysis system 104, the system controller 116, another portion of the system 100, or combinations thereof can compare the level of one or more analytes of interest detected by the analysis system 104 to a threshold amount (e.g., a level to ensure a purity of the fluid for use) to determine whether the amount in the fluid sample is at or less than the threshold amount. Alternatively or additionally, the method 500 can determine whether the level of one or more analytes of interest is at or below a threshold amount or at or above a threshold amount, dependent on the analyte(s) of interest. For instance, if an analyte of interest is desired to be at or above a threshold amount in order to be used in a specific chemical process, then the method 500 can determine whether the analytes measured by the analysis system 104 meet or exceed the threshold amount (i.e., whether the chemical sample is suitable for use in the chemical process).

If the level of one or more analytes of interest in the fluid sample is determined in block 506 to be above the threshold amount or is otherwise unsuitable for use, the method 500 proceeds to block 508, where the sample is rejected. Alternatively, the sample could still be retained, but the bottle label can be associated with data that indicates that the sample is a rejected sample.

If the level of one or more analytes of interest in the fluid sample is below the threshold amount or is otherwise suitable for use, the method 500 proceeds to block 510, where the fluid sample is directed to a sample retention system. For example, the system 100 can direct the fluid sample into the sampling line 124 to pass the fluid sample into the sample retention system 102. The method 500 also includes retaining a portion of the fluid sample in a capped bottle via the sample retention system in block 512. For example, the fluid sample can be directed to flush internal fluid lines of the sample retention system 102 and to fill the sample loop 122 prior to introduction the bottle (e.g., as described with reference to FIG. 2). In implementations, the bottle also can be pre-rinsed with a portion of the fluid sample. The bottle can then be capped via the uncapper 112, or can remain uncapped for verification of the retained sample with the bottle in the uncapped state.

The method 500 also includes withdrawing a portion of the retained fluid sample from the bottle via the sample retention system in block 514. For example, the bottle can be uncapped via the uncapper 112 (e.g., where the bottle was previously capped or recapped by the uncapper 112) and the sample probe 118 can be introduced to the bottle to draw a portion of the retained sample for analysis. Alternatively or additionally, a different sample probe can be introduced to the bottle to draw a portion of the retained sample for analysis, such as a sample probe integrated with the analysis system 104. In implementations, the sample retention system 102 or the analysis system includes a verification sample loop that differs from the sample loop 122 to hold a subset of the portion of the retained sample, allowing the remainder of the retained sample to remain in the bottle for subsequent reanalysis. For example, in implementations, the verification sample loop can have a volume that is less than 50% of the volume of the sample loop 122.

The method 500 also includes transferring the portion of the retained fluid sample to the sample analysis system in block 516. For instance, the portion of the retained sample can be transferred to the analysis system 104 via the sampling line 124 or a different fluid line, transferred to a separate analysis system, or the like, or combinations thereof. For example, a different analysis system that that used in block 204 can be used to receive the verification sample, such as to compare analysis results between different analyzers (e.g., to determine whether an analysis error is introduced via the first analysis system or the second analysis system).

The method 500 also includes detecting a level of one or more analytes of interest in the portion of the retained fluid sample in block 518. For example, the analysis system 104 can detect an amount or concentration of one or more analytes of interest (e.g., metals content, organic content, or the like) of the retained fluid sample received from the sample probe 118, which can be used to determine whether the level of the one or more analytes of interest in the retained fluid sample remains below the threshold amount (or otherwise suitable for use) subsequent to being introduced to the bottle.

The method 500 also includes comparing the results of the analysis of the retained fluid sample and the results of the analysis of the initial fluid sample in block 520. For example, the analysis system 104, the system controller 116, another portion of the system 100, or combinations thereof can compare the level of one or more analytes of interest detected by the analysis system 104 in the retained sample to the level of one or more analytes of interest detected by the analysis system 104 in the initial sample analyzed in block 504 to determine whether the analyte(s) of interest substantially changed from the initial sample analysis to the retained sample analysis. The method 500 also includes determining whether the results of the analyses of the initial fluid sample and the retained fluid sample match in block 522. If the results are determined to match, then the method 500 proceeds to block 524 where the retained fluid sample is verified as being substantially the same as the initial fluid sample (i.e., transferring the fluid sample to the bottle via the sample retention system did not substantially alter the sample). Determining whether the results match can occur according to any suitable statistical process, such as determining whether the results differ more than a threshold amount (e.g., differ by more than 15%, more than 10%, more than 5%, more than 1%, etc.).

If the results are determined not to match in block 522, then the system 100 can perform a variety of operations including, but not limited to, generate an error, automatically take another portion of the retained sample for retesting, send the portion or another portion of the retained sample to a different analysis system for analysis, flag the bottle containing the retained sample as containing an unverified retained sample (e.g., by associating the identifier on the bottle with data indicating the unverified retained sample), or the like, or combinations thereof. For instance, unmatching results can indicate that the bottle included contaminate residue (e.g., from a surrounding environment, from an improper rinse procedure, from a prior sample residue, or the like), that a capping procedure introduced a foreign contaminate to the retained sample (e.g., physical material worn from the cap/bottle, residue held in the cap, or the like), or combinations thereof. In implementations, the system 100 can provide a variety of procedures to verify the retained sample, such as by taking a portion of the retained sample prior to capping the bottle, capping and then uncapping the bottle before taking a portion of the retained sample for analysis, or the like.

Electromechanical devices (e.g., electrical motors, servos, actuators, or the like) may be coupled with or embedded within the components of the system 100 to facilitate automated operation via control logic embedded within or externally driving the system 100. The electromechanical devices can be configured to cause movement of devices and fluids according to various procedures, such as the procedures described herein. The system 100 may include or be controlled by a computing system having a processor or other controller configured to execute computer readable program instructions (i.e., the control logic) from a non-transitory carrier medium (e.g., storage medium such as a flash drive, hard disk drive, solid-state disk drive, SD card, optical disk, or the like). The computing system can be connected to various components of the system 100, either by direct connection, or through one or more network connections (e.g., local area networking (LAN), wireless area networking (WAN or WLAN), one or more hub connections (e.g., USB hubs), and so forth). For example, the computing system can be communicatively coupled to the system controller 116, the motors manipulating the uncapper 112 and the sample probe 118, fluid handling systems (e.g., valves, pumps, etc.), other components described herein, components directing control thereof, or combinations thereof. The program instructions, when executed by the processor or other controller, can cause the computing system to control the system 100 (e.g., control positioning of the uncapper 112 and the sample probe 118, control movement of fluids via the sample probe, etc.) according to one or more modes of operation, as described herein.

It should be recognized that the various functions, control operations, processing blocks, or steps described throughout the present disclosure may be carried out by any combination of hardware, software, or firmware. In some embodiments, various steps or functions are carried out by one or more of the following: electronic circuitry, logic gates, multiplexers, a programmable logic device, an application-specific integrated circuit (ASIC), a controller/microcontroller, or a computing system. A computing system may include, but is not limited to, a personal computing system, a mobile computing device, mainframe computing system, workstation, image computer, parallel processor, or any other device known in the art. In general, the term “computing system” is broadly defined to encompass any device having one or more processors or other controllers, which execute instructions from a carrier medium.

Program instructions implementing functions, control operations, processing blocks, or steps, such as those manifested by embodiments described herein, may be transmitted over or stored on carrier medium. The carrier medium may be a transmission medium, such as, but not limited to, a wire, cable, or wireless transmission link. The carrier medium may also include a non-transitory signal bearing medium or storage medium such as, but not limited to, a read-only memory, a random access memory, a magnetic or optical disk, a solid-state or flash memory device, or a magnetic tape.

### Conclusion

It will be appreciated that features described herein with respect to embodiments or implementations can be combined with any other feature or features described with respect to the same or alternative embodiments, unless context otherwise dictates, without departing from the scope of the present disclosure.

Although the subject matter has been described in language specific to structural features and/or process operations, it is to be understood that the subject matter defined in the appended claims is not necessarily limited to the specific features or acts described above. Rather, the specific features and acts described above are disclosed as example forms of implementing the claims.

What is claimed is:

1. An automated system for retaining and storing chemical samples within capped sample vessels following chemical analysis, comprising:
an analysis system configured to receive a fluid sample and measure an amount of one or more analytes of interest in the fluid sample; and
a sample retention system fluidically coupled with the analysis system via a fluid transfer line, the sample retention system including
an uncapper configured to remove a cap from a bottle to provide an uncapped bottle and to replace the cap to the bottle to provide a capped bottle,
a sample probe configured to dispense the fluid sample into the uncapped bottle,
a sample loop fluidically coupled with the sample probe and the fluid transfer line and configured to hold a portion of the fluid sample, and
a controller communicatively coupled with the analysis system, the uncapper, and the sample probe, the controller configured to
determine whether the amount of one or more analytes of interest in the fluid sample measured by the analysis system is within a threshold amount,
transfer the portion of fluid sample into the sample loop to provide a retained sample portion,
instruct the uncapper to remove the cap from the bottle to provide the uncapped bottle,
instruct the sample probe to introduce the sample probe into the uncapped bottle, and
transfer the retained sample portion from the sample loop, through the sample probe, and into the uncapped bottle to provide a retained sample.

2. The automated system of claim 1, wherein the controller is further configured to instruct the uncapper to replace the cap to the uncapped bottle holding the retained sample to provide the capped bottle holding the retained sample.

3. The automated system of claim 1, wherein the controller is further configured to instruct the sample probe to remove a portion of the retained sample from the uncapped bottle and to direct the sample to the analysis system to measure an amount of one or more analytes of interest in the retained sample.

4. The automated system of claim 3, wherein the controller is further configured to compare amount of one or more analytes of interest in the retained sample with the amount of one or more analytes of interest in the fluid sample.

5. The automated system of claim 4, wherein the controller is further configured to determine whether the amount of one or more analytes of interest in the retained sample is within a threshold amount of the amount of one or more analytes of interest in the fluid sample.

6. The automated system of claim 3, wherein the controller is further configured to instruct the uncapper to replace the cap to the uncapped bottle holding the retained sample and to remove the cap from the capped bottle prior to instructing the sample probe to remove the portion of the retained sample from the uncapped bottle.

7. The automated system of claim 3, wherein the uncapped bottle remains uncapped from a first time when the retained sample is introduced to the uncapped bottle through a second time when the controller instructs the sample probe to remove the portion of the retained sample from the uncapped bottle.

8. The automated system of claim 3, wherein the portion of the retained sample from the uncapped bottle is less than a total amount of the retained sample.

9. The automated system of claim 1, wherein the controller is further configured to instruct the sample probe to remove a portion of the retained sample from the uncapped bottle and to direct the sample to a second analysis system to measure an amount of one or more analytes of interest in the retained sample.

10. The automated system of claim 1, further comprising a fluid sensor communicatively coupled with the controller, wherein the controller is further configured to, prior to transferring the retained sample portion into the uncapped bottle, verify that the fluid sensor detects no liquid within the bottle.

11. An automated sample retention system for retaining and storing chemical samples within capped sample vessels following chemical analysis, comprising:
a sample retention system fluidically coupled, via a fluid transfer line, with an analysis system an analysis system configured to receive a fluid sample and measure an amount of one or more analytes of interest in the fluid sample, the sample retention system including
an uncapper configured to remove a cap from a bottle to provide an uncapped bottle and to replace the cap to the bottle to provide a capped bottle,
a sample probe configured to dispense the fluid sample into the uncapped bottle,
a sample loop fluidically coupled with the sample probe and the fluid transfer line and configured to hold a portion of the fluid sample, and
a controller communicatively coupled with the uncapper and the sample probe, the controller configured to
transfer the portion of fluid sample into the sample loop to provide a retained sample portion when the amount of one or more analytes of interest in the fluid sample measured by the analysis system is within a threshold amount,
instruct the uncapper to remove the cap from the bottle to provide the uncapped bottle,
instruct the sample probe to introduce the sample probe into the uncapped bottle, and
transfer the retained sample portion from the sample loop, through the sample probe, and into the uncapped bottle to provide a retained sample.

12. The automated sample retention system of claim 11, wherein the controller is further configured to instruct the uncapper to replace the cap to the uncapped bottle holding the retained sample to provide the capped bottle holding the retained sample.

13. The automated sample retention system of claim 11, wherein the controller is further configured to instruct the sample probe to remove a portion of the retained sample from the uncapped bottle and to direct the sample to the analysis system to measure an amount of one or more analytes of interest in the retained sample.

14. The automated sample retention system of claim 13, wherein the controller is further configured to compare amount of one or more analytes of interest in the retained sample with the amount of one or more analytes of interest in the fluid sample.

15. The automated sample retention system of claim 14, wherein the controller is further configured to determine whether the amount of one or more analytes of interest in the retained sample is within a threshold amount of the amount of one or more analytes of interest in the fluid sample.

16. The automated sample retention system of claim 13, wherein the controller is further configured to instruct the uncapper to replace the cap to the uncapped bottle holding the retained sample and to remove the cap from the capped bottle prior to instructing the sample probe to remove the portion of the retained sample from the uncapped bottle.

17. The automated sample retention system of claim 13, wherein the uncapped bottle remains uncapped from a first time when the retained sample is introduced to the uncapped bottle through a second time when the controller instructs the sample probe to remove the portion of the retained sample from the uncapped bottle.

18. The automated sample retention system of claim 13, wherein the portion of the retained sample from the uncapped bottle is less than a total amount of the retained sample.

19. The automated sample retention system of claim 11, wherein the controller is further configured to instruct the sample probe to remove a portion of the retained sample from the uncapped bottle and to direct the sample to a second analysis system to measure an amount of one or more analytes of interest in the retained sample.

20. The automated sample retention system of claim 11, further comprising a fluid sensor communicatively coupled with the controller, wherein the controller is further configured to, prior to transferring the retained sample portion into the uncapped bottle, verify that the fluid sensor detects no liquid within the bottle.
